(19) United States
(12) Patent Application Publication
(10) Pub. No.: US 2010/0195039 A1
(43) Pub. Date: Aug. 5, 2010

(54) DISPLAY APPARATUS AND METHOD OF MANUFACTURING THE SAME

(75) Inventor: Jung Woo PARK, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si, (KR)

(21) Appl. No.: 12/622,629

(22) Filed: Nov. 20, 2009

(30) Foreign Application Priority Data
Feb. 3, 2009 (KR) 10-2009-0008531

(51) Int. Cl. G02F 1/1345; H01J 9/20; H01J 9/42

(52) U.S. Cl. 349/152; 445/24; 445/3

(57) ABSTRACT

In a method of manufacturing a display apparatus, an opposite substrate on which a conductive pattern is formed is coupled with a display substrate to face the display substrate, and the opposite substrate is cut to partially expose the display substrate. Since the conductive pattern is cut with the opposite substrate during the cutting of the opposite substrate, an electric resistance of the conductive pattern is changed. The change in electric resistance of the conductive pattern is detected to determine whether the opposite substrate is cut or not.

This application claims priority to Korean Patent Application No. 10-2009-0008531 filed on Feb. 3, 2009, and all the benefits accruing therefrom under 35 U.S.C. §119, the contents of which are herein incorporated by reference in its entirety.

### BACKGROUND OF THE INVENTION

1. Field of the Invention

The present invention relates to a display apparatus and a method of manufacturing the same. More particularly, the present invention relates a display apparatus capable of preventing defects in manufacturing process and a method of manufacturing the display apparatus.

2. Description of the Related Art

Among flat panel displays, a flexible display indicates a display device which is flexibly bendable. The flexible display includes a plastic substrate having a thickness of about 0.2 millimeters (mm) which imparts flexibility to the display device, rather than a glass substrate of a relatively hard material which imparts rigidity.

When manufacturing the flat panel display, two substrates are coupled to each other while facing each other. One of the two substrates is selectively cut to expose the other substrate to an exterior in order to bond a driving chip to the exposed other substrate among the two substrates of the flat panel display. In a manufacturing method of a liquid crystal display including a glass substrate, the selective cutting process for only one substrate of the two substrates is performed such as by using a scribing wheel. However, in the manufacturing method of the flexible display including the plastic substrate, the thickness of the plastic substrate is too thin to reliably and accurately cut only one substrate of the two substrates by using the scribing wheel.

### BRIEF SUMMARY OF THE INVENTION

An exemplary embodiment of the present invention provides a display apparatus capable of reducing or effectively preventing defects in a manufacturing process.

Another exemplary embodiment of the present invention provides a method of manufacturing the display apparatus.

In an exemplary embodiment of the present invention, a method of manufacturing a display apparatus is provided as follows. A plurality of pixels is formed on a first substrate to manufacture a display substrate, and a conductive pattern is formed on a second substrate to manufacture an opposite substrate. The display substrate is coupled with the opposite substrate, and the second substrate is cut with the conductive pattern to cut the opposite substrate such that the display substrate is partially exposed.

In addition, a change in electric resistance of the conductive pattern is detected during the cutting of the opposite substrate to check whether or not the opposite substrate is cut. The opposite substrate is accurately cut while the display substrate is coupled with the opposite substrate, and the opposite substrate being incompletely cut or damaged by cutting the opposite substrate is reduced or effectively prevented.

In another exemplary embodiment of the present invention, a display apparatus includes a first substrate including a display area and a peripheral area surrounding the display area, a plurality of pixels arranged in the display area, a second substrate facing the first substrate, and a plurality of conductive lines.

The conductive lines are arranged on the second substrate corresponding to the peripheral area. First ends of the conductive lines are electrically connected to each other, and second ends arranged opposite to the first ends are spaced apart from each other.

The display apparatus may be a liquid crystal display which further includes a liquid crystal interposed between the display substrate and the opposite substrate.

The display substrate may include the first substrate having flexibility, such as a plastic substrate, and the opposite substrate may include the second substrate having flexibility, such as the plastic substrate.

The opposite substrate may be cut using a laser beam.

In the exemplary embodiments, an intensity of the laser beam may be controlled by detecting the change in electric resistance of the conductive pattern while the display substrate and the opposite substrate are coupled to each other. Therefore, the opposite substrate being incompletely cut due to a lack of the intensity of the laser beam, and the display substrate being damaged due to an excessive intensity of the laser beam may be reduced or effectively prevented.

### BRIEF DESCRIPTION OF THE DRAWINGS

The above and other advantages of the present invention will become readily apparent by reference to the following detailed description when considered in conjunction with the accompanying drawings wherein:

FIG. 1 is a side view showing an exemplary embodiment of a liquid crystal display according to the present invention;

FIG. 2 is a partially enlarged plan view showing an exemplary embodiment of an edge of the liquid crystal display of FIG. 1;

FIG. 3A is a cross-sectional view taken along line I-I′ of FIG. 2;

FIG. 3B is a cross-sectional view taken along line II-II′ of FIG. 2;

FIG. 4 is a plan view showing another exemplary embodiment of a liquid crystal display according to the present invention; and

FIGS. 5 to 8 are plan, perspective and cross-sectional views showing an exemplary embodiment of a method of manufacturing the liquid crystal display of FIG. 1.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

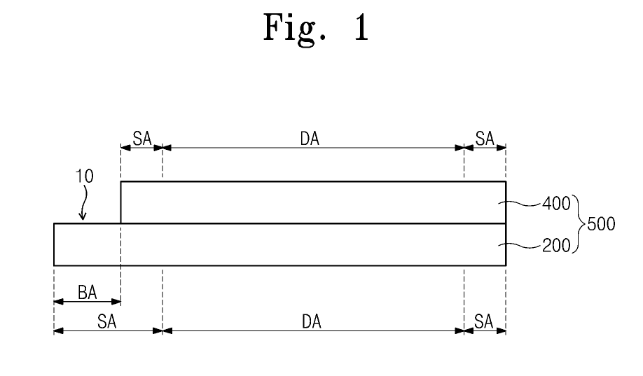

FIG. 1 is a side view showing an exemplary embodiment of a liquid crystal display according to the present invention.

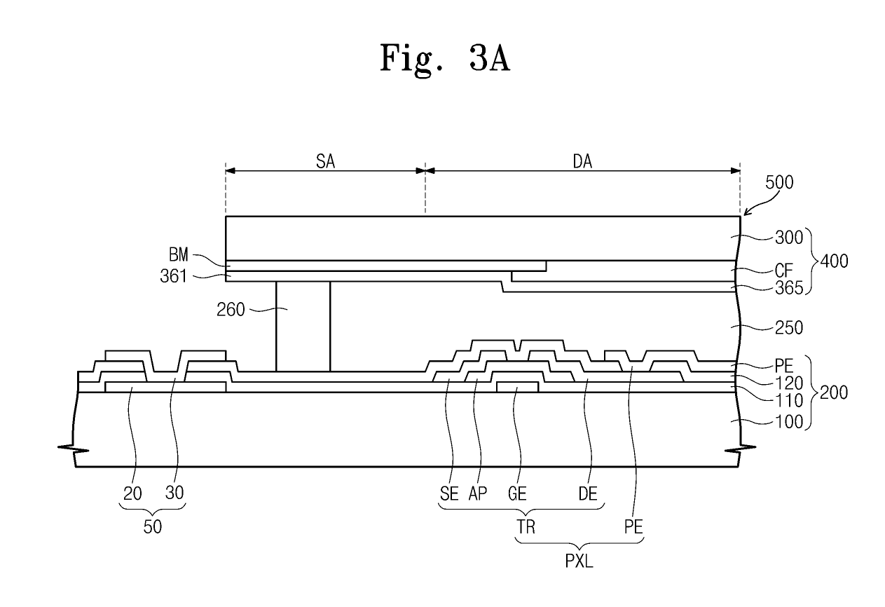

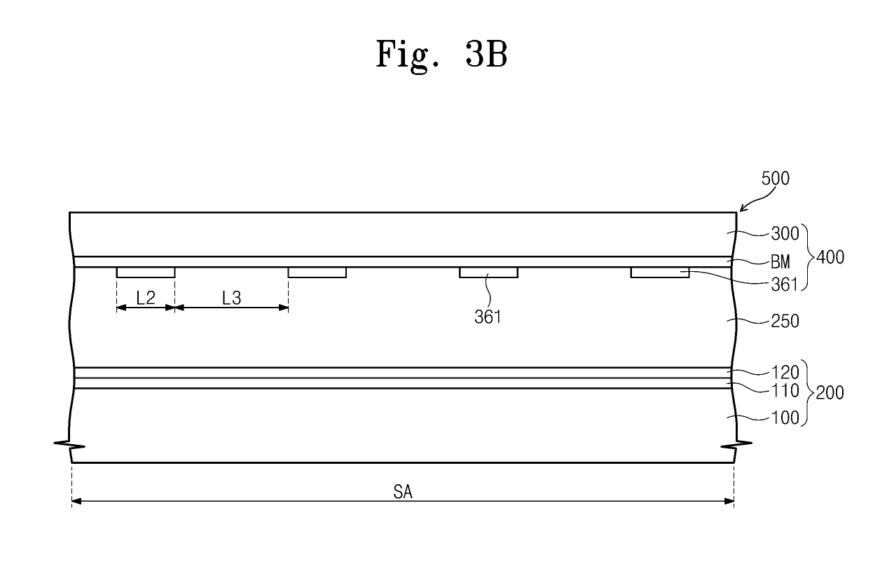

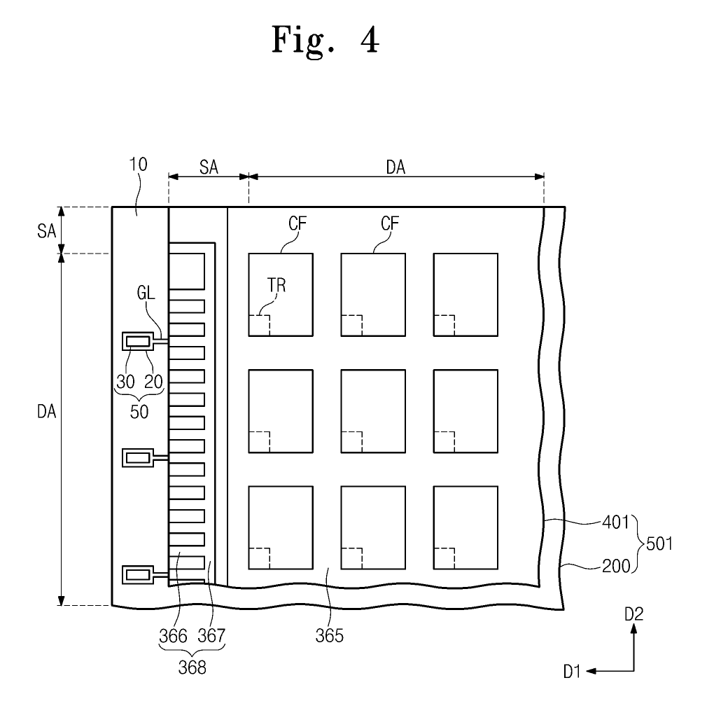

Referring to FIG. 1, a liquid crystal display (“LCD”) 500 includes a display substrate 200, an opposite substrate 400 facing the display substrate 200, and a liquid crystal 250 (shown in FIG. 3A) interposed between the display substrate 200 and the opposite substrate 400.

The display substrate 200 includes a first substrate 100 (shown in FIG. 3A) which is flexible, such as including a plastic material, so that the display substrate 200 may have flexibility. In addition, the opposite substrate 400 includes a second substrate 300 which is flexible, such as including a plastic material, so that the opposite substrate 400 may have flexibility. Although external forces are applied to the LCD 500, the LCD 500 may be flexibly bent and deformed, thereby advantageously reducing or effectively preventing the LCD 500 from being damaged.

Each of the display substrate 200 and the opposite substrate 400 includes a display area DA and a peripheral area SA. The display area DA is an area on which images are displayed, and the peripheral area SA surrounds the display area DA. A portion of the peripheral area SA may be respectively disposed between the display area DA and each outer edge of the display substrate 200 and the opposite substrate 400. The display substrate 200 is coupled with the opposite substrate 400 in the peripheral area SA. An inner boundary of the peripheral area of the opposite substrate 400 and the display substrate 200 may coincide with (e.g., are aligned with) each other as illustrated in FIG. 1.

The peripheral area SA of the display substrate 200 includes a bonding area BA. The display substrate 200 includes a bonding portion 10 corresponding to the bonding area BA. As used herein, “corresponding” may refer to as being related in positional relationship, dimension and/or shape to another element. The bonding part 10 includes a plurality of a bonding pad part 50 (shown in FIG. 3A). The bonding pad parts 50 are coupled to, such as by bonding, with elements (not shown) which provide driving signals to the display substrate 200. The elements providing driving signals to the display substrate 200 include, but are not limited to, a driving chip, a bumper of a flexible printed circuit board, or the like. Accordingly, the display substrate 200 may receive the driving signals used to drive the display substrate 200 from the driving chip or the flexible printed circuit board.

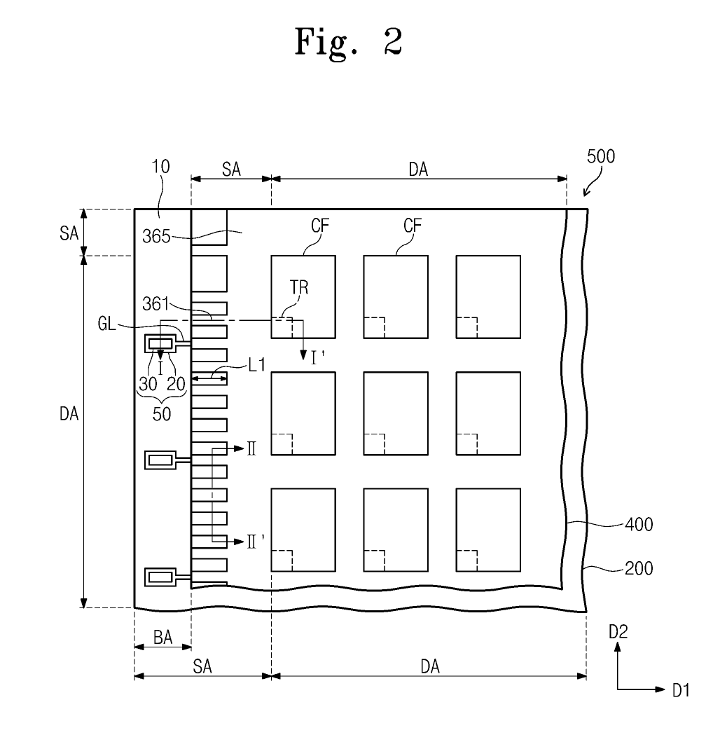

FIG. 2 is a partially enlarged plan view showing an exemplary embodiment of an edge of the liquid crystal display of FIG. 1. In FIG. 2, elements for the opposite substrate 400 will mainly be described. FIG. 3A is a cross-sectional view taken along line I-I′ of FIG. 2, and FIG. 3B is a cross-sectional view taken along line II-II′ of FIG. 2.

Referring to FIGS. 2, 3A, and 3B, the LCD 500 includes the display substrate 200, the opposite substrate 400, and the liquid crystal 250 interposed between the display substrate 200 and the opposite substrate 400. The display substrate 200 is coupled with the opposite substrate 400 by a coupling member 260 which is interposed between the display substrate 200 and the opposite substrate 400, and corresponding to the peripheral area SA.

The display substrate 200 includes the display area DA and the peripheral area SA, and the peripheral area SA includes the bonding area BA and surrounds the display area DA. Also, the display substrate 200 includes the first substrate 100, a plurality of pixels arranged in the display area DA, and the bonding pad parts 50 arranged in the bonding area BA.

In the illustrated exemplary embodiment, the first substrate 100 is a plastic substrate. More particularly, the first substrate 100 includes a plastic material, such as polyethylene terephthalate (“PET”), poly carbonate (“PC”), polyethylene naphthalate (“PEN”), polyether sulfone (“PES”), or fiber reinforced plastic (“FRP”). In addition, the first substrate 100 has a thickness which is equal to or less than about 0.2 millimeters (mm) and has flexibility.

The pixels are disposed on the first substrate 100 corresponding to the display area DA. Since each of the pixels have substantially the same structure and function, only one pixel PXL will be described in FIG. 3A as a representative pixel, and thus others will be omitted. The pixel PXL includes a pixel electrode PE and a thin film transistor TR electrically connected to the pixel electrode PE to switch a driving signal applied to the pixel electrode PE.

Although not shown in detail in drawings, a plurality of gate lines (not shown) and a plurality of data lines (not shown) crossing the gate lines are arranged on the first substrate 100. Each pixel is electrically connected to a corresponding gate line among the gate lines and a corresponding data line among the data lines. Therefore, gate signals transmitted through the gate lines may control operations of the pixels, so that data signals transmitted through the data lines may be applied to the pixels.

The thin film transistor TR includes a gate electrode GE, an active pattern AP, a source electrode SE, and a drain electrode DE. The gate electrode GE may branch from the gate line GL and is disposed on the first substrate 100. The gate line GL including the branched gate electrode GE may be a unitary, continuous and indivisible member. The active pattern AP includes a semiconductor material such as amorphous silicon or polysilicon and is disposed on the gate electrode GE. A gate insulating layer 110 is interposed between the gate electrode GE and the active pattern AP to insulate the gate electrode GE and the active pattern AP. The source electrode SE can branch from each data line and is disposed on the active pattern AP, and the drain electrode DE is spaced apart from the source electrode SE and disposed on the active pattern AP. The data line including the branched source electrode SE may be a unitary, continuous and indivisible member.

The pixel electrode PE is electrically connected to the thin film transistor TR. More particularly, the thin film transistor TR is covered (e.g., overlapped) by an inter-insulating layer 120. The pixel electrode PE is disposed on the inter-insulating layer 120 to cover (e.g., overlap) an area of the thin film transistor TR where the inter-insulating layer 120 is partially removed to expose a portion or the drain electrode DE. Thus, the pixel electrode PE and the drain electrode DE are electrically connected to each other where the inter-insulating layer 120 is partially removed.

Each of the bonding pad parts 50 includes a terminal 20 branching from the gate line GL and a pad 30 electrically connected to the terminal 20. The gate line GL including the branched terminal 20 may be a unitary, continuous and indivisible member. More particularly, the terminal 20 is partially covered (e.g., overlapped) by the gate insulating layer 110 and the inter-insulating layer 120. The pad 30 is disposed on the inter-insulating layer 120 to overlap an area from which both the gate insulating layer 110 and the inter-insulating layer 120 are partially removed to expose the terminal 20. As a result, the pad 30 and the terminal 20 are electrically connected to each other where the gate insulating layer 110 and the inter-insulating layer 120 are partially removed. In the illustrated exemplary embodiment, the pad 30 and the pixel electrode PE may include the same material.

The opposite substrate 400 includes the second substrate 300, color filters CF, a black matrix BM, a common electrode 365, and conductive lines 361.

In the illustrated exemplary embodiment, the second substrate 300 is a plastic substrate like the first substrate 100. The second substrate 300 has a thickness equal to or less than about 0.2 mm and has flexibility.

The color filters CF are disposed on the second substrate 300 corresponding to the display area DA of the opposite substrate 400. In exemplary embodiments, the color filters CF may include red, green, and blue color filters, and a white light is filtered through the color filters CF to have a predetermined color. The black matrix BM is disposed on the second substrate 300 substantially corresponding to the peripheral area SA of the opposite substrate 400. A portion of the black matrix BM may also be disposed in the display area DA, as illustrated in FIGS. 2 and 3A. The black matrix BM is disposed in areas between adjacent color filters CF, and in areas between an outer edge of the opposite substrate 400 directly adjacent to color filters CF and the color filters CF to block a light.

The common electrode 365 is disposed on the second substrate 300 corresponding to the display area DA of the opposite substrate 400. A portion of the common electrode 365 may also be disposed in the peripheral area SA, as illustrated in FIGS. 2 and 3A. The common electrode 365 may be disposed overlapping an entire of the second substrate 300. In the illustrated exemplary embodiment, the common electrode 365 includes a transparent conductive material, such as indium tin oxide (“ITO”) and indium zinc oxide (“IZO”), and forms an electric field in cooperation with the pixel electrode PE to control a director of the liquid crystal 250.

The conductive lines 361 branch from the common electrode 365, and each conductive line 361 longitudinally extends substantially in a first direction D1. Also, the conductive lines 361 are arranged in a second direction D2 which is substantially perpendicular to the first direction D1. The conductive lines 361 arranged along the second direction D2 are spaced apart from each other by an interval. As illustrated in FIG. 2, an entire of the conductive lines 361 is disposed within the peripheral area SA of the opposite substrate 400. In an exemplary embodiment, the conductive lines 361 may be disposed only in the peripheral area SA of the opposite substrate 400 and not in the display area DA of the opposite substrate 400. The conductive lines 365 may be arranged along at least one edge among edges of the opposite substrate 400. The common electrode 365 including the branched conductive lines 361 is a unitary, continuous and indivisible member.

In the illustrated exemplary embodiment, a first length L1 (shown in FIG. 1) which represents a (longitudinal) length taken in the first direction D1 of each conductive line 361 is about 2 millimeters, a second length L2 (shown in FIG. 3B) which represents a width of each conductive line 361 taken in the second direction D2 is about 3 micrometers, and a third length L3 (shown in FIG. 3B) which represents the interval between adjacent conductive lines 361 arranged in the second direction D2 is about 10 micrometers. However, the first, second, and third lengths should not be limited thereto.

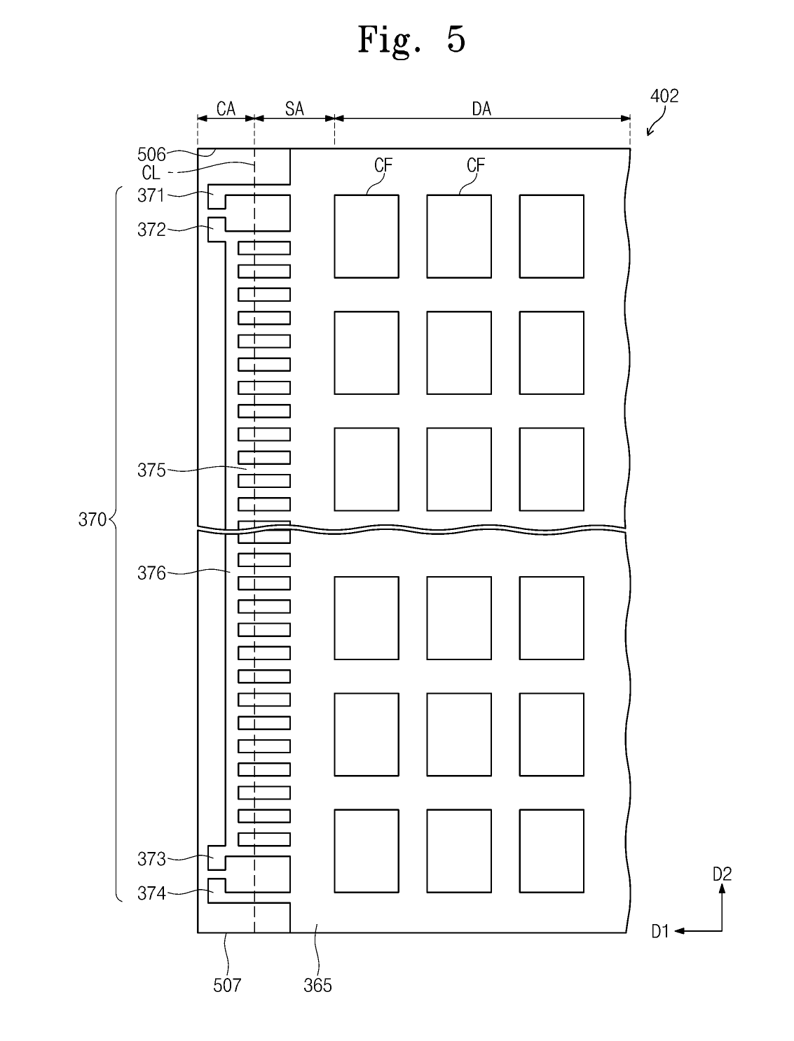

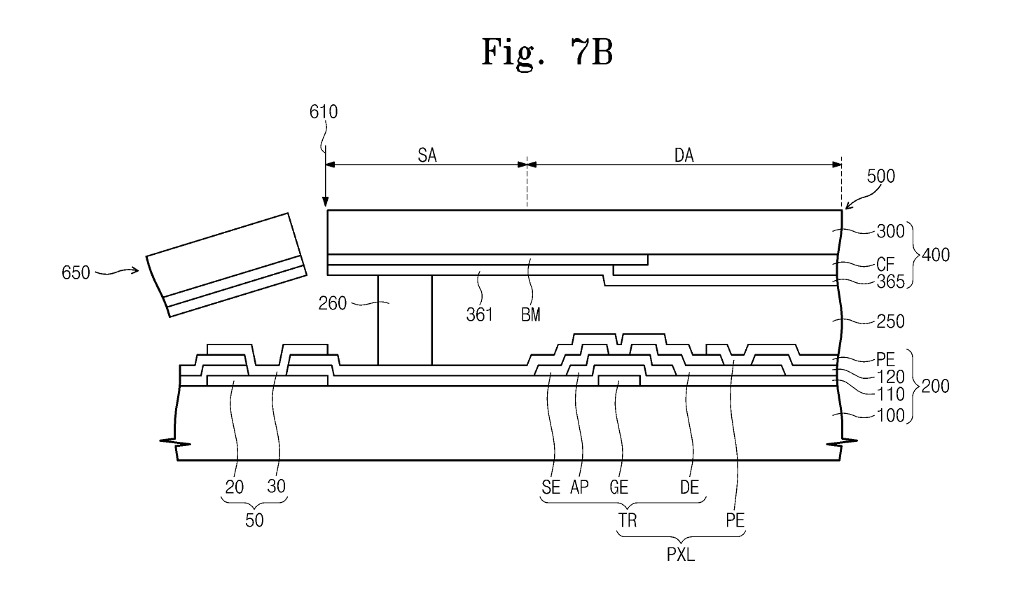

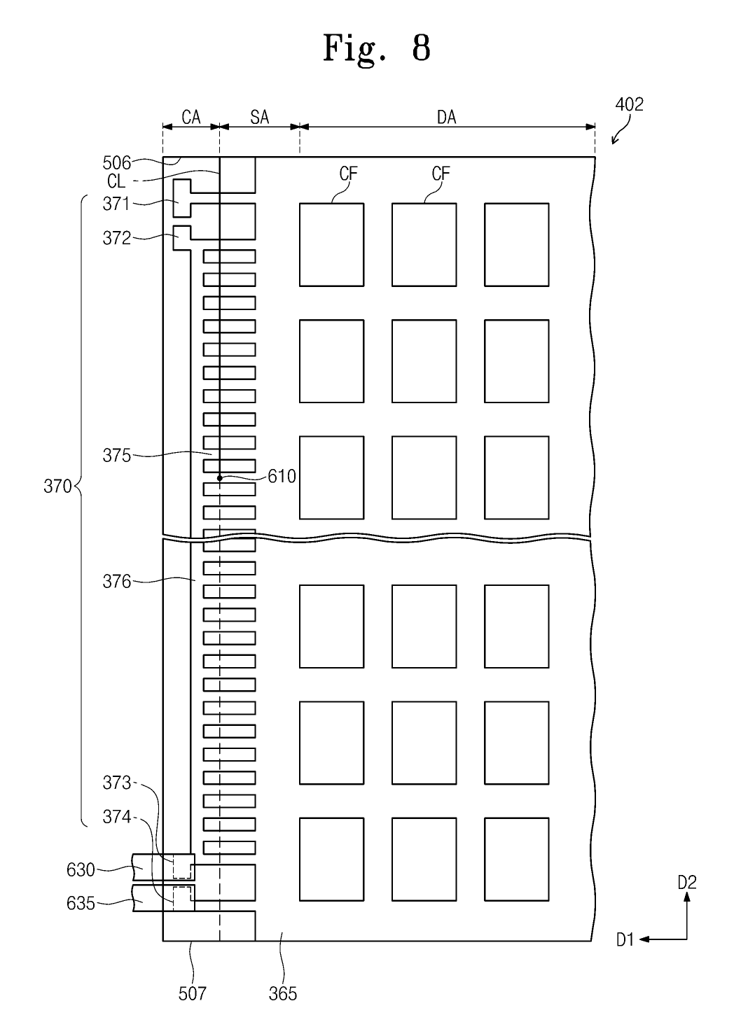

Since each conductive line 361 branches from the common electrode 365, and is indivisibly continuous with the common electrode 365, the conductive lines 361 are electrically connected to each other by the common electrode 365. Also, as shown in FIG. 3A, ends (e.g., distal ends) of the conductive lines 361 are each disposed on an extended portion of one side of the second substrate 300. The distal ends of the conductive lines 361 are disposed on an extended portion of one side of the second substrate 300 because when a preliminary opposite substrate 402 (shown in FIG. 7A) is partially cut to form the opposite substrate 400, a preliminary substrate 301 (shown in FIG. 7A) is cut with a conductive pattern 370 (shown in FIG. 8) to substantially simultaneously form the second substrate 300 and the conductive lines 361. More detailed descriptions of the above will be described with reference to FIGS. 5 to 8.

FIG. 4 is a plan view showing another exemplary embodiment of a liquid crystal display according to the present invention. In FIG. 4, the same reference numerals denote the same elements in FIGS. 1 to 3, and thus the detailed descriptions of the same elements will be omitted.

Referring to FIG. 4, an opposite substrate 401 includes a plurality of conductive lines 368 which is spaced apart from a common electrode 365 in the plan view. The conductive lines 368 include first conductive lines 366 longitudinally extended in a first direction D1 and a second conductive line 367 longitudinally extended in a second direction D2 to connect first ends of the first conductive lines 366 to each other. Second ends of the first conductive lines 366 which are disposed opposite to the first ends are arranged spaced apart from each other along the second direction D2. The conductive lines 368, including the first conductive lines 366 and the second conductive line 367, define a unitary, continuous and indivisible member, while the common electrode 365 is also a unitary, continuous and indivisible member. Since the conductive lines 368 are indivisibly continuous with each other, the first conductive lines 366 and the second conductive line 367 are electrically connected to each other.

In the illustrated exemplary embodiment, a length and a width of each first conductive line 366, and a distance (e.g., interval) between the first conductive lines 366 may be the same as those of L1, L2 and L3 of the conductive lines 361, respectively, shown in FIG. 2.

FIGS. 5 to 8 are plan, perspective and cross-sectional views illustrating an exemplary embodiment of a method of manufacturing the liquid crystal display of FIG. 1. In FIGS. 5 to 8, the same reference numerals denote the same elements in FIGS. 1, 2, 3A and 3B, and thus the detailed descriptions of the same elements will be omitted.

Referring to FIG. 5, a preliminary opposite substrate 402 is prepared. The preliminary opposite substrate 402 is used to form the opposite substrate 400 (shown in FIG. 2). More particularly, the opposite substrate 400 is formed by cutting the preliminary opposite substrate 402 along a cutting line CL to remove a cutting area CA of the preliminary opposite substrate 402.

Referring again to FIGS. 2 and 3A, during the process of manufacturing the preliminary opposite substrate 402, the common electrode 365, the black matrix BM, the color filters CF, and the conductive pattern 370 are formed on the second substrate 300. After the preliminary opposite substrate 402 is formed, the conductive pattern 370 is cut with the preliminary opposite substrate 402 to form the conductive lines 361. In an exemplary embodiment, the common electrode 365 is formed with the conductive pattern 370 through a same photolithography process using a same photomask. The conductive pattern 370 for forming the conductive lines 361 and 368 may include a same material as the common electrode 365.

The conductive pattern 370 includes a first inspection pad 371, a second inspection pad 372, a third inspection pad 373, a fourth inspection pad 374, a plurality of inspection lines 375, and a connection line 376 connecting the inspection lines 375 to each other. Each inspection line 375 branches from the common electrode 365 and longitudinally extends in the first direction D1, and the inspection lines 375 are arranged in the second direction D2 while being spaced apart from each other. The connection line 376 longitudinally extends in the second direction D2 to connect first ends of the inspection lines 375 to each other. The first and second inspection pads 371 and 372 branch from two inspection lines 375, which are directly adjacent to a first edge 506 of the preliminary opposite substrate 402, among the inspection lines 375. In addition, the third and fourth inspection pads 373 and 374 branch from two inspection lines 375, which are adjacent to a second edge 507 facing the first edge 506, among the inspection lines 375.

The first and second edges 506 and 507 of the preliminary opposite substrate 402 are disposed opposing each other, at a first side and a second side of the preliminary opposite substrate 402. The conductive pattern 370 including the first inspection pad 371, the second inspection pad 372, the third inspection pad 373, the fourth inspection pad 374, the plurality of inspection lines 375 and the connection line 376 is a unitary, continuous and indivisible member. The inspection lines 375 are essentially extended from and continuous with portions of the conductive pattern 370 that will ultimately form the conductive lines 361 (shown in FIGS. 2, 3A and 3B) and the conductive lines 368 (shown in FIG. 4) when the inspection lines 375 are cut in forming the LCD.

As described above, since the first ends of the inspection lines 375 are connected to each other by the connection line 376, second ends of the inspection lines 375 are connected to the common electrode 365, and the inspection lines 375 are spaced apart from each other, the inspection lines 375 are electrically connected to each other in parallel. When an inspection needle makes contact with the first and second inspection pads 371 and 372, or the inspection needle makes contact with the third and fourth inspection pads 373 and 374, an electric resistance of the conductive pattern 370 may be measured. An intensity of the electric resistance may depend on a length and a width of each inspection line 375 and the number of the inspection lines 375 which are electrically connected to each other in parallel.

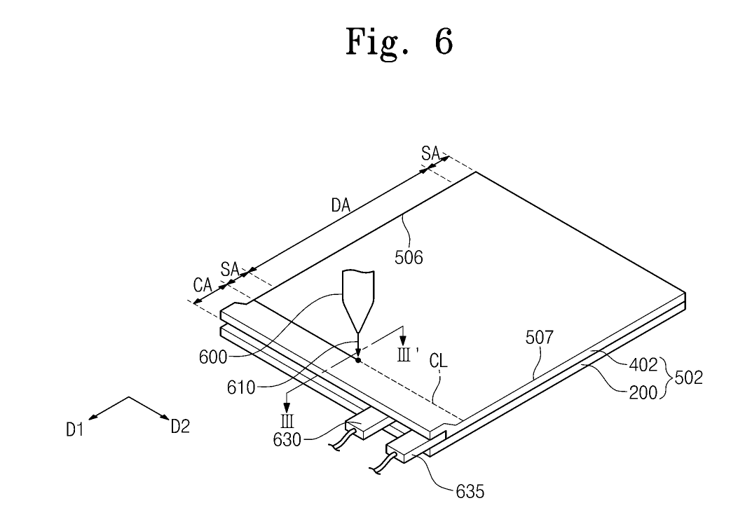

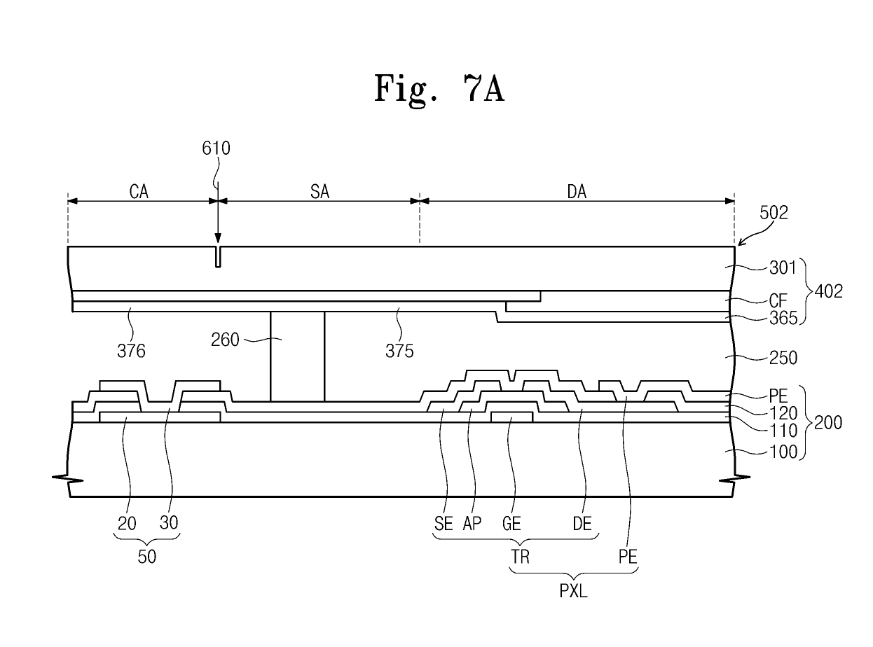

Referring to FIGS. 5 and 6, after forming the preliminary opposite substrate 402, the liquid crystal 250 (shown in FIG. 3A) is provided to the preliminary opposite substrate 402 or the display substrate 200, and the preliminary opposite substrate 402 is coupled with the display substrate 200 by the coupling member 260 (shown in FIG. 3A) to form a preliminary liquid crystal display 502. More particularly, the coupling member 260 is provided to the peripheral area SA of the preliminary opposite substrate 402 or the display substrate 200 and used to couple the preliminary opposite substrate 402 and the display substrate 200.

In an inspection process, a first inspection needle 630 makes contact with the third inspection pad 373, and a second inspection needle 635 makes contact with the fourth inspection pad 374 to measure the electric resistance of the conductive pattern 370. In the illustrated exemplary embodiment, each of the preliminary opposite substrate 402 and the display substrate 200 includes a thin plastic substrate and has flexibility, and the coupling member 260 is not provided in the cutting area CA between the preliminary opposite substrate 402 and the display substrate 200. Thus, when the preliminary opposite substrate 402 and the display substrate 200 are separated from each other at the edge of the cutting area CA, the first and second inspection needles 630 and 635 can be disposed between the preliminary opposite substrate 402 and the display substrate 200 and may make contact with the third inspection pad 373 and the fourth inspection pad 374 in a one-to-one correspondence.

As illustrated in FIG. 6, a laser beam 610 is irradiated onto the preliminary opposite substrate 402 along the cutting line CL using a laser cutter 600. When the laser beam 610 is irradiated along the cutting line CL from the first edge 506 to the second edge 507, a portion 650 (shown in FIG. 7B) corresponding to the cutting area CA of the preliminary opposite substrate 402 is removed, thereby completely manufacturing the opposite substrate 400 (shown in FIG. 7B). When the portion 650 of the preliminary opposite substrate 402 including portions of the conductive pattern 370 is removed, conductive lines 361 (shown in FIGS. 2, 3A and 3B) and the conductive lines 368 (shown in FIG. 4) are formed. A planar area of the completed opposite substrate 400 including the conductive lines is less than the preliminary opposite substrate 402 due to the removal of the portion 650 corresponding to the cutting area CA of the preliminary opposite substrate 402.

In the illustrated exemplary embodiment, the first inspection needle 630 makes contact with the third inspection pad 373, the second inspection needle 635 makes contact with the fourth inspection pad 374, and the laser beam 610 is irradiated along the cutting line CL from the first edge 506 to the second edge 507. Although not shown in drawings, the first inspection needle 630 may make contact with the first inspection pad 371, the second inspection pad 635 may make contact with the second inspection pad 372, and the laser beam 610 may be irradiated along the cutting line CL from the second edge 507 to the first edge 506.

When cutting the preliminary opposite substrate 402 using the laser beam 610, it is desirable to control an intensity of the laser beam 610 in order to completely cut only the preliminary opposite substrate 402 while reducing or effectively preventing damage to the display substrate 200 by the laser beam 610. In one exemplary embodiment, where the laser beam 610 has the intensity corresponding to the intensity of about 90% of the laser beam 610 which is required to cut the preliminary opposite substrate 402 is provided to the preliminary opposite substrate 402, the preliminary opposite substrate 402 may not be completely cut. On the contrary, where the laser beam 610 has the intensity corresponding to the intensity of about 110% of the laser beam 610 which is required to cut the preliminary opposite substrate 402 is provided to the preliminary opposite substrate 402, the preliminary opposite substrate 402 may be completely cut. However, since the intensity of the laser beam 610 provided to the preliminary opposite substrate 402 exceeds a level of the laser beam 610 required to cut the preliminary opposite substrate 402, the display substrate 200 disposed under the preliminary opposite substrate 402 may be damaged by the laser beam 610.

Therefore, when the preliminary opposite substrate 402 is cut using the laser beam 610, the intensity of the laser beam 610 provided to the preliminary opposite substrate 402 should be controlled accurately. In the illustrated exemplary embodiment, the intensity of the laser beam 610 may be adjusted with reference to changes of electric resistance of the conductive pattern 370 (shown in FIG. 5), which are measured by the first and second inspection needles 630 and 635. More detailed descriptions of the above will be described with reference to FIGS. 7A, 7B, and 8.

FIGS. 7A and 7B are cross-sectional views taken along line III-III′ of FIG. 6. Particularly, FIGS. 7A and 7B show an exemplary embodiment of processes of cutting a portion of the preliminary opposite substrate 402 by the laser beam. FIG. 8 is a plan view illustrating the process of cutting the portion of the preliminary opposite substrate 402, and elements of the preliminary opposite 402 substrate are mainly described in FIG. 8.

Referring to FIGS. 7A, 7B, and 8, after the first inspection needle 630 makes contact with the third inspection pad 373 and the second inspection needle 635 makes contact with the fourth inspection pad 374, the preliminary opposite substrate 402 is cut using the laser cutter 600 (shown in FIG. 6). More particularly, the laser beam 610 is irradiated along the cutting line CL from the first edge 506 to the second edge 507 to cut the preliminary opposite substrate 402.

The inspection lines 375 branch from the common electrode 365 to cross (e.g., intersect) a borderline between the peripheral area SA and the cutting area CA of the preliminary opposite substrate 402. Thus, when the preliminary opposite substrate 402 is cut by the laser beam 610, the inspection lines 375 are cut by the laser beam 610. The severed inspection lines 375

As described earlier, the inspection lines 375 serve as electric resistances connected to each other in parallel. Therefore, while the preliminary opposite substrate 402 is being cut, as the number of inspection lines 375 cut by the laser beam 610 increases, the electric resistance of the conductive pattern 370 measured at the third and fourth inspection pads 373 and 374 increases. In one exemplary embodiment, when one of the inspection lines 375 is cut on the assumption that the electric resistance of each inspection line 375 is n ohm and the number of inspection lines 375 is m (m is a natural number), the electric resistance measured at the third and fourth inspection pads 373 and 374 increases from n/m ohm to n/(m−1) ohm.

Referring to the cross-sectional views of FIGS. 7A and 7B, the inspection lines 375 are disposed at an uppermost portion of the preliminary opposite substrate 402, and the inspection lines 375 are cut after the second substrate 300 at a lowermost portion of the preliminary opposite substrate 402 is cut by the laser beam 610. Thus, a timing at which the inspection lines 375 are cut is substantially the same as a timing at which the second substrate and the preliminary opposite substrate 402 is cut. As a result, when the electric resistance measured at the third and fourth inspection pads 373 and 374 increases during the process of cutting the preliminary opposite substrate 402, the timing at which the inspection lines 375 are cut by the laser beam 610 may be checked, so that the timing at which the preliminary opposite substrate 402 is cut may be checked.

As described above, the timing at which the preliminary opposite substrate 402 is cut may be checked by detecting the change of the electric resistance of the conductive pattern 370 measured at the third and fourth inspection pads 373 and 374. Advantageously, damage to the display substrate 200 due to an excessive intensity of the laser beam 610 provided to the preliminary opposite substrate 402 may be reduced or effectively prevented. In addition, the preliminary opposite substrate 402 being incompletely cut due to a lack of intensity of the laser beam 610 provided to the preliminary opposite substrate 402 may be reduced or effectively prevented.

In the illustrated exemplary embodiment, the change in electric resistance of the conductive pattern 370 is measured at the third and fourth inspection pads 373 and 374, however, the change in electric resistance may be measured at the first and third inspection pads 371 and 373 or the second and fourth inspection pads 372 and 374.

According to the exemplary embodiment of the manufacturing method of the liquid crystal display, the intensity of the laser beam provided to the preliminary opposite substrate 402 may be controlled as follows. First, when the laser beam 610 is initially irradiated onto the preliminary opposite substrate 402, the laser beam 610 having the intensity lower than the intensity of the laser beam 610 required to cut the preliminary opposite substrate 402 is provided to the preliminary opposite substrate 402. Then, the intensity of the laser beam gradually increases to detect the timing at which the electric resistance measured at the third and fourth inspection pads 373 and 374 begins to be increased. As described above, when the electric resistance measured at the third and fourth inspection pads 373 and 374 begins to be increased, it can be determined that a portion of the preliminary opposite substrate 402, onto which the laser beam 610 is irradiated, is completely cut.

Assuming that the intensity of the laser beam 610 corresponding to the timing at which the electric resistance measured at the third and fourth inspection pads 373 and 374 begins to be increased is a first intensity, the laser beam 610 having the first intensity may be uniformly provided to the preliminary opposite substrate 402 during the cutting process of the preliminary opposite substrate 402. However, where the laser beam having the first intensity is uniformly provided to the preliminary opposite substrate 402, cutting quality of the preliminary opposite substrate 402 may be adversely affected by a uniformity of thickness of the preliminary opposite substrate 402, such as when there are variations in the thickness of the preliminary opposite substrate 402.

Therefore, in the illustrated exemplary embodiment of the method of controlling the intensity of the laser beam provided to the preliminary opposite substrate 402, the preliminary opposite substrate 402 may be cut using the following processes in order to improve the cutting quality of the preliminary opposite substrate 402. That is, instead of uniformly providing the laser beam 610 having the first intensity to the preliminary opposite substrate 402, the laser beam 610 having the first intensity is irradiated first. Then, the laser beam 610 having 10% smaller intensity (e.g., a second intensity) than the first intensity is provided, and the intensity of the laser beam increases from the second intensity. After that, when the electric resistance measured at the third and fourth inspection pads 373 and 374 increases as the number of inspection lines 375 cut by the laser beam 610 increases, the increase of the intensity of the laser beam 610 from the second intensity stops. The intensity of the laser beam 610 returns to the first intensity, and the process is repeated along the cutting line CL of the preliminary opposite substrate 402. When repeatedly performing the processes as stated above, the intensity of the laser beam 610 needed to cut the preliminary opposite substrate 402 may be frequently adjusted and controlled according to a location of the preliminary opposite substrate 402.

According to the above, the intensity of the laser beam may be adjusted and controlled by detecting the change in electric resistance of the conductive pattern while the display substrate and the opposite substrate are coupled to each other. Advantageously, the opposite substrate being incompletely cut due to the lack of the intensity of the laser beam, and the display substrate being damaged due to the excessive intensity of the laser beam may be reduced or effectively prevented.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method of manufacturing a display apparatus, the method comprising:
forming a plurality of pixels on a first substrate to manufacture a display substrate;
forming a conductive pattern on a second substrate to manufacture an opposite substrate;
coupling the display substrate with the opposite substrate; and
cutting the second substrate including the conductive pattern to separate a cut portion from the opposite substrate such that the display substrate is partially exposed when the cut portion of the opposite substrate is removed,
wherein the cutting the second substrate comprises detecting a change in electric resistance of the conductive pattern during the cutting of the second substrate to determine whether or not the second substrate is cut.

2. The method of claim 1, wherein the cutting the second substrate further comprises a laser beam sequentially irradiated onto the second substrate and the conductive pattern to cut the opposite substrate.

3. The method of claim 2, wherein the cutting the second substrate further comprises:
measuring the electric resistance of the conductive pattern prior to the cutting the second substrate;
irradiating the laser beam along a cutting line of the second substrate; and
checking whether or not the opposite substrate is cut during the cutting of the second substrate by the laser beam to control an intensity of the laser beam irradiated onto the second substrate.

4. The method of claim 3, wherein the forming a conductive pattern to manufacture the opposite substrate comprises
forming a plurality of conductive lines on the second substrate, the conductive lines being electrically connected to each other in parallel, and
wherein the conductive lines cross the cutting line and are spaced apart from each other while being arranged along the cutting line.

5. The method of claim 4, wherein a number of the conductive lines increases as an area onto which the laser beam is irradiated along the cutting line increases, thereby causing increase in the electric resistance of the conductive pattern.

6. The method of claim 4, wherein each conductive line has a width of about 3 micrometers, a minimum value of a distance between two adjacent conductive lines is about 10 micrometers, and each conductive line has a length equal to or less than 2 millimeters.

7. The method of claim 3, wherein the controlling an intensity of the laser beam comprises:
decreasing the intensity of the laser beam irradiated onto the second substrate when the electric resistance of the conductive pattern increases;
increasing the decreased intensity of the laser beam;
stopping the increase of the intensity of the laser beam when the electric resistance of the conductive pattern increases.

8. The method of claim 1, wherein the forming of the opposite substrate comprises forming a common electrode on the second substrate, the common electrode forming an electric field in cooperation with the pixels.

9. The method of claim 8, wherein the common electrode is formed with the conductive pattern through a same photolithography process using a same photomask.

10. The method of claim 1, wherein the first substrate and the second substrate are flexible substrates.

11. A display apparatus comprising:
a first substrate including a display area and a peripheral area surrounding the display area;
a plurality of pixels disposed in the display area;
a second substrate facing the first substrate; and
a plurality of conductive lines disposed on the second substrate, corresponding to the peripheral area, first ends of the conductive lines being electrically connected to each other, and second ends of the conductive lines being spaced apart from each other and disposed opposite to the first ends.

12. The display apparatus of claim 11, wherein the conductive lines longitudinally extend in a same direction, and the conductive lines are spaced apart from each other and arranged along at least one edge among edges of the second substrate.

13. The display apparatus of claim 12, further comprising bonding pads disposed on the first substrate and electrically connected to the pixels, to be exposed externally, and wherein the bonding pads are arranged adjacent to the conductive lines in a plan view.

14. The display apparatus of claim 11, wherein the first substrate and the second substrate are flexible substrates.

15. The display apparatus of claim 11, further comprising:
a liquid crystal interposed between the first substrate and the second substrate; and
a common electrode disposed on the second substrate corresponding to the display area to form an electric field in cooperation with the pixels.

16. The display apparatus of claim 15, wherein the conductive lines are branched from the common electrode such that the conductive lines and the common electrode form a unitary indivisible member, and the first ends of the conductive lines are connected to each other.

17. The display apparatus of claim 16, wherein the second ends of the conductive lines are arranged along the at least one edge of the second substrate and spaced apart from each other.

18. The display apparatus of claim 15, wherein the conductive lines are spaced apart from the common electrode in a plan view.

19. The display apparatus of claim 18, wherein the conductive lines are arranged along at least one edge among edges of the second substrate, the first ends of the conductive lines are connected to each other, and the second ends of the conductive lines are spaced apart from each other.

20. The display apparatus of claim 18, wherein the conductive lines comprise a same material as the common electrode.
